(19) United States
(12) Patent Application Publication
(10) Pub. No.: US 2006/0116974 A1
(43) Pub. Date: Jun. 1, 2006

(54) Searchable molecular database

(76) Inventors: Philip Anthony Ashworth, Berkshire (GB); Tim Cheesright, Cambridge (GB); Mark Denis Mackey, Essex (GB); Jeremy Gilbert Vinter, Hertfordshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/526,334

(22) PCT Filed: Sep. 5, 2003
(86) PCT No.: PCT/GB03/03868

§ 371 Date: Mar. 2, 2005

(30) Foreign Application Priority Data
Sep. 6, 2002 (GB) 0220790.0

(51) Int. Cl. G06F 17/30

(52) U.S. Cl. 707/1

(57) ABSTRACT

A computer system comprising a database (100) having a plurality of records, is provided. Each record comprises a filed point representation representing field extrema for a conformation of a chemical structure. The database may include records for multiple conformations of the same chemical structure. Each record can have a searchable index of the filed point representation. In one embodiment the index is bit string. An indexing mechanism for generating an index, a searching mechanism for searching the database and a graphical user interface to enable a user to interface with the database (100) are also provided.

### BACKGROUND OF THE INVENTION

The invention relates to a database of representations of molecules in different conformations which can be searched in order to find molecular conformations with similar field properties, as is useful for drug discovery.

A number of databases exist which allow comparison between structural representations of large numbers of molecules in different conformations [see e.g. references 1, 2]. Databases of this kind are useful for pharmaceutical research, since a known compound with a particular known activity can be used as a search query to identify other compounds with similar molecular structures. These other compounds can then be used as leads and can be studied to establish whether they exhibit similar activity.

One way to compare molecular conformations is to perform atom-atom searching in which each atom and, bond of a molecule (including properties such as valence charge) is compared. Many algorithms have been produced to accomplish atom-atom comparison searching. A popular algorithm is that produced by Ullman or derivations based upon it. Whilst atom-atom searching is an effective way of comparing molecules, it is computationally intensive and hence slow. Search speeds become unacceptably slow for the average user even when searching across databases containing only a modest number of records.

To speed up the searching process it is conventional to initially perform an index-based search before atom-atom searching, which is then limited to the hits found in the index-based search. An index is a condensed representation of a molecular conformation. A commonly used index type is the bit string (also referred to as a bit map). Bit strings can be rapidly compared using bit-wise operations.

For each molecular conformation an index is created from a definition of the conformation based on its structural properties, such as its atom types and properties of the inter-atomic bonds, such as bond length, angle etc. Two common bit string indexing methods use structural key indexes (also referred to as data dictionary indexes) and fingerprint indexes (also referred to as hashed indexes).

Much work has been carried on devising less specific representations for molecules. These take features of a molecule and reduce them to character representations, for example aromatic rings (A), linker chains (CH2) (L), electron withdrawing atoms (W), electron donating atoms (D), hydrogen acceptor atoms (HA), and hydrogen donating groups (HD). This allows a complex molecule to be represented by a simple abbreviated reduced molecule. These reduced molecules can be indexed just as if they had full atom representation, and used in search and metric calculations.

Through the use of similarity metrics researchers have devised clustering methods. These include K-Means, Nearest-Neighbour and Jarvis-Patrick algorithms, to name a few. These allow sets of bit strings to be grouped into bins or clusters, indicating that some relationship exists between them. Once clustered the bit strings may be further analysed to search for common bits (features) which tend to predominate in specific groups. These features have then been utilised further in quantitative structure-activity relationship (QSAR) analysis to relate biological activity with bit features. QSAR analysis is a standard term describing the calculation or measurement of one or more properties of a set of molecules and then attempting to relate the biological activities of the molecules to their properties (e.g. by regression).

While index-based searching across molecular databases has proved to be a powerful tool, it has some limitations. In particular, the searching is not generally good at finding new lead compounds which are structurally dissimilar to the search query compound. This is a consequence of the structure-based approach used in existing databases for the indexing. It is therefore desired to create a molecular database with an improved indexing system which is capable of finding lead compounds independent of structural similarity.

### SUMMARY OF THE INVENTION

Viewed from a first aspect the present invention provides a computer system comprising a database having a plurality of records, wherein each record comprises a field point representation representing field extrema for a conformation of a chemical structure.

Field point representations are independent of the structural class of a chemical structure. By providing a database with records comprising field point representations, searches can be performed by field point representation rather than chemical structure. Advantageously, searches can identify chemical structures of different structural class to that of a search query. Thus, the database can provide hits which are not be obtainable by known chemical structure databases and hits that are likely to have diverse chemical structures.

In a particular embodiment the database includes records for multiple conformations of the same chemical structure. Advantageously, multiple field point representations for the same chemical structure can be searched, increasing the likelihood of the chemical structure being included as a hit in the search results.

In one embodiment an index of the field point representation is associated with each record, the index being a searchable representation of the field point representation.

Preferably the index is a string. Each element of the string may be a binary digit (bit) so that the string is a bit string. Alternatively, the string elements may be more than two-valued, for example they may have values in the range 0 to 3 or 1 to 10. In this case the string elements are referred to as bins. (Use of bits for the string elements can thus be thought of as a special case in which the bin can only adopt two-values.) In one embodiment the string elements or bins take real number values (rather than being restricted to integer values). Advantageously, by using a string, known string manipulation techniques can be used.

Multiple indexes of the field point representation may be associated with each record, the multiple indexes being representations of the field point representation at different precision levels. This enables a user to search at different precision levels.

In a preferred embodiment, the index is a string of length n and the computer system comprises an indexing mechanism for generating an index of a field point representation. The indexing mechanism is configured to:

(i) generate a numeric identifier from a characteristic of the field point representation;

(ii) generate one or more numbers in a range from 1 to n (e.g. 0 to n-1) in dependence on the numeric identifier;

(iii) increment the bins in the string that correspond to the one or more numbers; and

(iv) optionally repeat (i) to (iii) for another characteristic of the field point representation.

Thus, a mechanism for generating a string from a field point representation is provided.

A characteristic of the field point representation may include one or more of:

the number of field points of a particular field of the field point representation;

the particular field and energy of a field point in the field point representation; and

the respective energies of and distance between a field point pairing in the field point representation.

In a preferred embodiment the indexing mechanism is configured to generate one or more numbers in a range from I to n in dependence on the numeric identifier by using a deterministic function, such as a pseudo-random number generator or a hash function.

The computer system may also comprise a searching mechanism configured to:

(i) compare a query index with an index of a field point representation for a record in the database;

(ii) identify the record as a hit if the comparison satisfies a search criterion; and

(iii) repeat (i) and (ii) for a plurality of records.

Viewed from another aspect the present invention provides a database for implementation on a computer system, the database configured to support a plurality of records, each record comprising a field point representation representing field extrema for a conformation of a chemical structure.

In another aspect the present invention provides computer software configured to provide the database defined herein and in a further aspect provides a carrier medium carrying the computer software.

Viewed from yet another aspect the present invention provides a method of generating an index of a field point representation representing field extrema for a conformation of a chemical structure, wherein the index is a string with n elements, the method comprising:

(i) generating a numeric identifier from a characteristic of the field point representation;

(ii) generating one or more numbers in a range from 1 to n in dependence on the numeric identifier;

(iii) incrementing the string elements that correspond to the one or more numbers; and

(iv) optionally repeating (i) to (iii) for another characteristic of the field point representation.

In the case that the string is a bit string, the incrementing step will be one of setting the bit to 1 (or the reverse in the case that the bit string is initialised to ones rather than zeroes). On the other hand, when the string elements are many-valued bins, the bin value is incremented until its maximum is reached.

The method may further comprise using a deterministic function to generate one or more numbers in a range from 1 to n in dependence on the numeric identifier.

Viewed from yet another aspect the present invention provides a method of searching a database having a plurality of records, each record comprising a field point representation representing field extrema for a conformation of a chemical structure and having an index of the field point representation, the method comprising:

(i) comparing a query index with an index of a field point representation for a record in the database;

(ii) identifying the record as a hit if the comparison satisfies a search criterion;

(iii) repeating (i) and (ii) for a plurality of records; and

(iv) outputting a representation of the records identified as a hit.

### BRIEF DESCRIPTION OF THE DRAWINGS

For a better understanding of the invention and to show how the same may be carried into effect reference is now made by way of example to the accompanying drawings in which:

FIG. 1 is a flow diagram illustrating the steps in the generation of a fieldprint;

FIG. 2 is a flow diagram illustrating the steps performed for fieldprint searching;

FIG. 3 is an overview of the database;

FIG. 4 illustrates the database schema; and

FIG. 5 is a schematic representation of a computer system.

### DETAILED DESCRIPTION

The present invention relates to a computer system comprising a database having a plurality of records, wherein each record comprises a field point representation representing field extrema for a conformation of a chemical structure.

The computer system comprises an indexing mechanism for generating a searchable index in the form of a bit string for each field point representation. A bit string is stored in the database for each record.

The computer system also comprises a searching mechanism for searching through the indexes stored in the database to identify field point representations that match the field point representation of a search query. Known searching algorithms can be used.

A suitable user interface, for example a graphical user interface (GUI) is provided to enable a user to interface with the database. A user can use the user interface to input data to and output data from the database, to search the database and to browse the database.

The following sections describe in more detail the field point representations, the generation of indexes and searching the database. After these sections an overview of a particular embodiment of a database is given, followed by a detailed description of the database structure of the particular embodiment and a description of a computer system.

I. Field Point Representations

It is possible to predict the binding properties of a candidate molecule, or other chemical structure, by representing the physical properties of a molecule which are important in its binding to other molecules, and then assessing the similarity between two such sets of physical properties, one for the candidate molecule and one for a well characterised molecule.

Accurate molecular modelling is possible using advanced quantum mechanics. However, the computational effort needed for quantum mechanics is prohibitive for most biologically relevant molecules.

An alternative approach is called molecular mechanics. The most common way of implementing molecular mechanics in three dimensions is to calculate and compare fields around a molecule, such as the steric (van der Waals) and electrostatic (Coulombic) fields. The principles of molecular mechanics are simple and empirical. Moreover, molecular mechanics is computationally fast enough to cope with large proteins and other biopolymers associated with drug design.

In molecular mechanics electrostatic properties of a molecule are defined by placing a point charge at the centre of each atom (atom-centred charges or ACCs). Many different methods for calculating or estimating the value of such point charges are described in the literature. The aim of ACC methods is to distribute the point charges in such a way that the resulting electrostatic field is as similar as possible to the true electrostatic field (as determined by quantum mechanics methods). The electrostatic field as approximated by ACCs is usually quite accurate at a distance from the molecule (>5 Å), but can be quite inaccurate at the molecular surface.

To improve the quality of molecular mechanics models at the molecular surface, extended electron distributions (XEDs) have been developed. The XED method involves replacing the point charge at the centre of some atoms with a set of point charges, one at the centre of the atom and one or more others distributed around that atom a short distance away. The XED method is described in Vinter (1994) [5] and Vinter and Trollope (1995) [6]. In the XED method, the XEDs themselves are treated simply as extra atoms which have charge but no volume. XED methods can therefore calculate electrostatic interactions more accurately than ACC methods, while retaining the speed advantages of the molecular mechanics framework.

Quantum mechanical models and molecular mechanical models, such as ACC or XED models, can use the concept of field points to represent the molecular field. In this approach, the conformation of a molecule, i.e. its equilibrium arrangement either in isolation or when bound to another specific molecule or surface, is represented by a set of field points which measure field strength at a relatively small number of field maxima and minima around the molecule which are relevant to how the molecule is likely to interact with other molecules.

In order to calculate field points, a field definition must be adopted. One known field definition for molecular mechanical models uses positive and negative electrostatic interaction fields in combination with a surface interaction field. The two electrostatic interaction fields are defined by the interaction energy of a specific charged ‘probe’ molecule with the molecule of interest. For example, a probe the size of an oxygen atom, with either a +1 or a −1 unit charge, can be used. The field value at a given point is the interaction energy of the molecule with the probe atom sited with its centre at that point. The surface interaction field is defined by the van der Waals interaction energy of a neutral ‘probe’ with the molecule, for example an uncharged oxygen atom.

Other field definitions have been used, for example ones that include electrostatic fields calculated from quantum molecular methods, and ones that include hydrophobic fields calculated from the electrostatic field and its partial derivatives. In principle, any field definition can be used provided that its value can be defined at any point in space around the molecule.

Once the field definition has been made, the field points of the molecule need to be calculated. With the molecular modelling approach, the field points are subdivided into a number of subsets, one for each field type, with each subset being calculated separately. The field points for a molecule are the values and locations of the extrema of its field, i.e. local maxima and minima. The final set of field points from each field type can be filtered to remove duplicate extrema and extrema with small energy values if desired.

The field point set encodes a large amount of information about the properties of the molecule, especially regarding its interaction with other molecules. The electrostatic field points encode information about the preferred hydrogen-bonding environment of the molecule, while the surface interaction field points encode the molecule's steric bulk.

The basic assumption underlying the field point approach is that two molecules which have similar sets of field points should have similar interactions with other molecules and hence should have similar biological activities. In other words, if molecule A has a certain biological activity, and molecule B is calculated to be similar to molecule A in a relevant conformation, then it is concluded that molecule B potentially has the same biological activity.

A field point representation therefore represents field extrema for a conformation of a chemical structure. Typically a field point representation includes a set of field points where each field point has a position and a field size value.

A field point representation may represent field extrema for a plurality of fields. In the example used herein the field point representation represents four fields, namely positive and negative electrostatic interaction fields, a surface interaction (i.e. steric) field, and a scaffold field.

Field point representations can be compared directly. For example, the similarity between conformations of two molecules can be calculated according to a scoring formula which is sensitive to differences between the field point positions and energy values of the field points in the two field point sets.

However, it is desirable to generate a searchable index of a field point representation so that indexes can be stored in the database and searched upon to perform a screen out before further comparisons of the search results are performed, if required. Generating searchable indexes of a field point representation is non-trivial.

Field point representations are also referred to as field patterns herein and the terms can be used interchangeably.

II. Index Generation

A searchable index of the field point representation is created in the form of a fingerprint-type bit string.

A fingerprint is generated from the molecule using a fingerprinting algorithm that examines the molecule and generates a pattern. Typical examples that are used include a pattern for each atom; a pattern for each atom and its nearest neighbour plus the joining bond; a pattern for each atom, its nearest neighbour, joining bond and further neighbours and bonds for varying path lengths; and a pattern for augmented atoms. The list of patterns produced is exhaustive, such that every pattern in the molecule up to the specified path length limit is generated. Each pattern serves as a seed to a pseudo-random number generator (i.e. it is hashed). The output of the pseudo-random number generator is a set of bits (typically 4 or 5 per pattern) which is added to the fingerprint with a logical OR. The creation of the seed is coded so as to produce a unique value for the pattern and hence the random number generation. Because each set of bits is produced by a pseudo-random number generator, it is likely that some bits will overlap. However, by setting 4 or 5 bits per pattern the probability that keys will be identical is reduced to an insignificant level for screen out purposes. The size of the bit string may be set independently since, unlike keys, a bit does not have an exact meaning in the fingerprint. A bit string size of 2K (2048 bits) is commonly used as a compromise between speed and overlap. However other fingerprint sizes such as 1K, 4K and 8K could be used.

Fingerprints have the important property that, if a pattern is a substructure of a molecule, every bit in the pattern's bit string will be set in the molecules bit string. This means that simple boolean or bit-wise operations can be used. Each bit of a fingerprint can be thought of as being shared among an unknown but large number of patterns. Each pattern generates its particular set of bits. So long as at least one of those bits is unique, it can be established if the pattern is present or not. If a fingerprint indicates a pattern is missing then it certainly is, but it can only indicate a patterns presence with some probability. Since fingerprints have no predefined set of patterns, one fingerprinting system can be used to serve all databases and all types of queries.

Although not used in the current implementation, the fingerprint may be folded. Folding is a term used to describe a process whereby a fingerprint is halved in size by performing a logical OR on each half of the fingerprint. The result is a shorter fingerprint with a higher bit density. One can continue to fold until the desired bit density is achieved. With each fold one increases the chances of a false positive but one saves half the space required to store the fingerprint. Since one can only compare fingerprints of the same length some work must be done when querying to ensure there are bit strings of suitable length available for comparison.

Bit string theory is described in Mooers (1951 and 1956) [3, 4]. The basic principles that can be used and some advanced techniques which may be applied to bit strings will now be described.

Bit strings are an array of bits that are either set to zero or one (True or False). The length of the bit strings can vary depending on the type of index being created.

When the presence of a substructure is tested the bit strings are compared using a logical AND. For example, consider the following two 8 bit bit strings A and B.

A: 10100100

B: 11100110

Imagine both have been created using the same indexing method for the characterisation of a molecule B and a substructure query A.

One can test to see if the substructure is likely to exist in the main molecule by testing the following equation as true or false
B & A=A where & is logical AND

For the example above a true result is produced, however if A is replaced with 10010100 a false result is produced. So one would know for certain that the substructure does not exist and should not waste time analysing the molecule further.

An exact match can be tested for by using B & A=B

The present system implementation allows bit strings to be compared for similarity using Tanimoto coefficient, Euclidian distance or Tversky similarity comparison techniques, each of which is now briefly described. Other bit-string comparison algorithms could also be provided. In one embodiment bit strings are compared for similarity using the Kulczynski metric.

The Tanimoto coefficient can be described as the number of bits in common between two bit strings divided by the total number of bits. This is an intuitive similarity measure as it is normalised to account for the number of bits that might be in common relative to the number that are in common. The equation can only be used as a similarity metric.

For two bit strings A and B their Tanimoto similarity is given by the equation
TS=BCm/(BCa+Bcb)−BCm
where

BCm is the number of bits set to 1 in common between the two bit strings

BCa is the count of bits set to 1 in bit string A

BCb is the count of bits set to 1 in bit string B

The results from this comparison range between 0 and 1, with 0 being the least similar and 1 being the most similar.

Euclidian distance is a measure of the geometric distance between two fingerprints, where each is thought of as a vector in multi-dimensional space. It can be used as a measure of similarity and as a substructure search metric depending on how it is applied.

Tversky similarity provides a most powerful metric. Like the Tanimoto metric, Tversky compares the features in a query bit string to features in the given (database) bit string. However, Tversky allows one to specify the weighting that will be given to each set of features. This allows the Tversky metric to be used in similarity, substructure and superstructure searching. The basic weightings are usually between 0 and 1 (0-100%) giving a ratio model. However the equation can be modified to accept weightings>100% thus providing a contrast model which causes distinguishing features to be emphasised more than the common features which may be more useful in diversity or dissimilarity metrics.

For two bit strings A and B their Tversky similarity is given by the equation
TvS=BCm/(αBCa+βBCb)−BCm
where

BCm is the number of bits set to 1 in common between the two bit strings

BCa is the count of bits set to 1 in bit string A

BCb is the count of bits set to 1 in bit string B

α is the weighting to be given to bit string A

β is the weighting to be given to bit string B

If both weightings are set to 100 then the Tversky equation gives the same results as the Tanimoto similarity. By varying the weightings the user can adjust how the bit strings are compared in terms of sub or super pattern similarity between the two bit strings.

Instead of the fingerprint bit string indexes used in the current implementation, data dictionary bit string indexes could be used.

Data dictionary indexes are also known as structural keys. A structural key is represented as a boolean array in which each element is true or false. Boolean arrays in turn are represented as bit strings in which each bit represents one position of the boolean array. A structural key is a bit string in which each bit represents the presence (true) or absence (false) of a specific structural feature (pattern). A fragment library is created of the patterns that are considered important, each pattern being assigned to a bit of the bit string. The number of fragments in the library dictates the bit string length. The bit string for a molecule is created by carrying out a substructure search of each structure or pattern in the fragment library and setting its corresponding bit in the bit string appropriately. Depending on the number of fragments in the library this can be a time consuming process. When a database is searched for a particular structural feature, a search key is generated. As the search proceeds, the search key is compared to the bit string of each molecule in the database. If a TRUE bit in the search key is not also set as TRUE in the molecule's key, then the structural feature represented by that bit is not in the molecule, so the molecule can be excluded from consideration.

Structural keys, like fingerprints, have the important property that, if a pattern is a substructure of a molecule, every bit in the pattern's bit string will be set in the molecules bit string, thus allowing boolean or bit-wise operations to be used to compare bit strings.

Using bit strings as indexes allows rapid bitwise comparison using simple AND, OR, XOR and NOT computer operations. They are also particularly suitable to use in similarity measures based on the numerous similarity formulae that exist. The method by which data is encoded into a bit string is known as fingerprinting. Whilst the use of fingerprinting and bit strings is known, the approach has never been applied to field point representations. In other words generating bit strings from field point representations is new.

In one embodiment an indexing mechanism is used to generate an index of a field point representation. The indexing mechanism may be implemented on a computer system as software, firmware or hardware, although in a particular embodiment it is implemented as software.

In a particular embodiment the index is a bit string of length n and the indexing mechanism is configured to:

(i) generate a numeric identifier from a characteristic of the field point representation;

(ii) generate one or more numbers in a range from 1 to n in dependence on the numeric identifier;

(iii) set the bits in the bit string that correspond to the one or more numbers; and

(iv) optionally repeat (i) to (iii) for another characteristic of the field point representation.

Thus, starting with a bit string of length n with all n bits set to zero (or indeed with all n bits set to 1), bits of the bits string can be set in dependence on one or more characteristics of the field point representation. Suitably, one or more characteristics are identified, one or more numeric identifiers are generated, and one or more numbers between 1 and n are generated. These features will now be described.

II.A. Characteristics

The characteristic of the field point representation can be any property and/or relationship that exists within the data.

The properties that can exist in a field point representation include the field type of each field point (for example negative, positive, surface, scaffold); the size or energy of each field point; the total number of field points; the number of each type of field point; and the X, Y, Z coordinates of a field point.

Relationships which can be derived from the properties include the pairwise distance relationship between two field points; the angles between three field points; the triangulation distances between three field points; any other relationship of interest between two or more field points

Any or all of the properties and relationships may be used by the indexing mechanism or a fingerprinting algorithm to generate an index (fingerprint) from a given field point representation (field pattern).

In one embodiment a characteristic of the field point representation includes one or more of:

the number of field points of a particular field of the field point representation;

the particular field and energy of a field point in the field point representation; and

the respective energies of and distance between a field point pairing in the field point representation.

A characteristic of the field point representation is used to generate a numeric identifier which in turn is used to generate one or more numbers between 1 and n for setting bits in the bit string. In order to understand the generation of the numeric identifier from a field point representation, the generation of one or more numbers between 1 and n in dependence on the numeric identifier will first be described.

II.B. Generation of Numbers Between 1 and n

In one embodiment the indexing mechanism is configured to generate one or more numbers in a range from 1 to n in dependence on the numeric identifier by using a deterministic function.

A deterministic function is a function which takes a value as an input value or seed and generates one or more output values in dependence on the input value such that the one or more output values for any given input value is always the same.

For example, if a deterministic function is seeded with the number 27 to produce four output values, it may output the values 0.23, 0.33, 0.21 and 0.88. If the same function is subsequently seeded with the number 27, then it will output the same four values, namely 0.23, 0.33, 0.21 and 0.88.

Deterministic functions can be used to generate one or more integer output values between 1 and a number n, by converting the output values to integers in this range. This can be done by scaling and rounding the output values.

For example, certain deterministic functions can generate all output values between 0 and 1. These can be scaled to an integer value between 1 and n by using the formula:
integer value=ROUND(output value*(n-1)+1)

An integer value generated in this way can be used to set a corresponding bit in a bit string. If, for example, the deterministic function is seeded to produce four output values from one seed (input value) then four integer values can be generated and used to set four bits in the bit string.

Examples of deterministic functions are hashing algorithms and pseudo random number generators. The current system implementation uses a pseudo random number generator.

In one embodiment known length bit strings are used. Starting with a bit string containing only a series of 0's, the basis of the approach is to create a unique identifier (number) for each and every property or relationship contained within the field pattern. The unique identifier is used as a seed to initialise a random number generator. The random number generator is used to provide a series a numbers (commonly 4 numbers) between 1 and the length of the bit string. The numbers produced are used to set the corresponding bit in the bit string to 1. After cycling around all the properties or relationships that are to be analysed, the bit string will contain a series of 0's and 1's which are unique to that field pattern.

An important part of creating any bit string index is to create the unique identifier for a defined property or relationship. Once created, the unique identifier will always produce the same sequence from a deterministic function.

II.C. Generation of the Numeric Identifier

The indexing mechanism can be configured to take a measurement of a characteristic to generate the numeric identifier.

In a particular example for generating a bit string (including the generation of the numbers in a range from 1 to n), the indexing mechanism uses the fingerprinting algorithm detailed below in pseudo code. The code is applied to each field point representation (field pattern) being stored in the database giving an index (fingerprint) for each record.

The code is exemplified using a bit string length of 2048 however; bit strings of any appropriate length can be used.

1. A bit string of length 2048 is created consisting entirely of 0's (zeros)

2. For each field type (negative, positive, surface, scaffold)
a. Count the number of field points of that type in the pattern.
b. Encode the field type and the field point count into a preferably unique numeric identifier
c. Seed a pseudo random number generator with the numeric identifier
d. Obtain four numbers from the pseudo random number generator between 0 and 2047 (to span a range from 1 to 2048 and use them to set the corresponding bit in the bit string to 1.

3. For each field point in the pattern
a. Encode the field type and the field point energy into a preferably unique numeric identifier
b. Seed a pseudo random number generator with the numeric identifier
c. Obtain four numbers from the pseudo random number generator between 0 and 2047 and use them to set the corresponding bit in the bit string to 1.

4. For each field point pairing in the field pattern
a. Calculate the distance (to a given precision) between the two points from their X, Y, Z coordinates.
b. Encode the two field types and distance between them into a unique numeric identifier
c. Seed a pseudo random number generator with the numeric identifier
d. Obtain four numbers from the pseudo random number generator between 0 and 2047 and use them to set the corresponding bit in the bit string to 1.

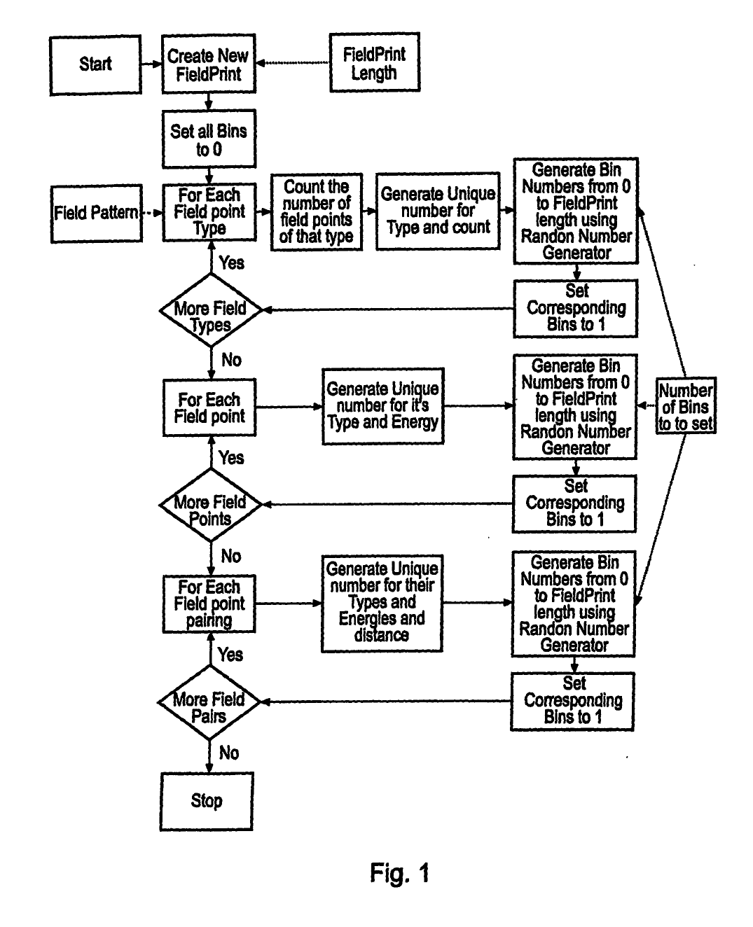

FIG. 1 illustrates a fingerprint generation method. It is noted that the flow diagram refers to bins rather than bits. However, the bins in this embodiment can only adopt values of 0 or 1, so that bin and bit are synonymous. In the more general case where each bin can adopt an arbitrary number of values, the step of “Set all bins to 0” will be the same, but the step of “Set corresponding bins to 1” will become one of incrementing the bin values.

The resulting fingerprint bit string contains a series of 1's and 0's which encodes the nature of the field pattern. The fingerprint generated is then stored in the database.

In step 4 it is possible to alter the precision at which the distance between two field points is measured. In the current example four precision levels (1, 0.5, 0.25 and 0.1 Angstroms) are used.

This means that for each field pattern registered to the database four Fingerprints are generated and stored in the database. This allows searches to be carried out over the database at different precision levels. Thus it will be appreciated that in one embodiment the indexing mechanism is configured to take a measurement of a characteristic at different levels of precision to generate corresponding multiple indexes which represent the field point representation at different precision levels.

Other methods can be used to encode the field pattern into a bit string. For instance three field point comparisons (Triangles) may be used rather than the two field point comparison detailed above. In this case the same procedures as outlined above can be used except in section 4 the information for each three field point grouping would be encoded.

In another embodiment the indexing mechanism is configured to:

(i) define a plurality of ranges of possible measurement values;

(ii) take a measurement of a characteristic of the field point representation to produce a measurement value;

(iii) assign the measurement value to a range if the measurement value is within the range;

(iv) optionally repeat (ii) and (iii); and

(v) use the number of measurement values assigned to a range to generate the numeric identifier.

In a particular example which uses a definition of a plurality of ranges, a numeric identifier is generated for each field point pair and used as a ‘seed’ for a pseudo-random number generator. Measurements are taken of the following characteristics:
the field type (one of four) for each field point
the field energy for each field point
the distance between the field points

There are 10 possibilities since there are 10 possible combinations of 4 field types, and these can therefore be encoded into a number between 1 and 10.

Ranges with a width that can be considered as an ‘energy precision parameter’ are defined for the energies. These ranges are used to convert each field point energy (measurement value) into an integer. For example:
0-5 becomes 1
5-10 becomes 2
10-15 becomes 3
   and so on.

The energy precision parameter determines the width of the ranges, which in the example above is 5.0. This means that field points with energy values between 0 and 5 are considered to be the ‘same’, those between 5 and 10 are the ‘same’ and so on.

The field point pair distance needs to be similarly encoded. Suitably, each possible distance is assigned an integer, such that if two distances are to be considered the ‘same’ then the integer assigned to them should be the same.

One method uses a constant distance resolution or precision level, so:
0-1 becomes 1
1-2 becomes 2
2-3 becomes 3
   and so on. This example has a distance resolution of 1, as all distances are rounded up to the nearest 1 Angstrom.

One example uses 4 ‘precision levels’ which correspond to different distance resolutions. In the example the 4 distance resolutions are 0.25, 0.5, 1.0 and 2.0. At 0.25, for example, the mapping is such that:
0-0.25 becomes 1
0.25-0.5 becomes 2
0.5-0.75 becomes 3
   and so forth.

In another example a lookup table is used to define the ranges and map the distances to integers. This removes the constraint that the distance resolution needs to be the same at all distances. For example, higher resolutions can be used at short distances, while lower resolutions can be used at long distances. In an example the mapping is such that:
0-0.1 becomes 1
0.1-0.2 becomes 2
0.2-0.4 becomes 3
0.4-0.7 becomes 4
0.7-1.0 becomes 5
1.0-2.0 becomes 6
2.0-5.0 becomes 7
5.0-10.0 becomes 8
10.0-20.0 becomes 9
>20.0 becomes 10

Thus in this example any distance is mapped to a number from 1 to 10 and distances of 0.23 and 0.53 are seen as ‘different’, but distances of 11.0 and 17.0 are the ‘same’, for example.

Once four integers for the field point pair have been generated (the one representing field types, the two representing the field sizes, and the one representing the field distance), these can be combined into a single integer for the field point pair.

For example, if the field types integer can be 1-10, the size values can be 1-10, and the distance value can be 1-100, then
K=(distance value)*1000+(size value 1)*100+(size value 2)*10+(types value)
encodes these four numbers into one number K in such a way that each value of K uniquely maps to a (dist, size1, size2, types) set. This number K is the numeric identifier which is then used as the seed to the hash function or pseudo random number generator which is used to set one or more bits in the bit string.

Thus it will be appreciated that using the above the indexing mechanism can be configured to define ranges of equal width across all ranges or to define a range for smaller measurement values with a narrower width than a range for larger measurement values. In a particular embodiment the indexing mechanism is configured to generate multiple indexes by defining ranges of different widths for different precision levels.

In a further example a numeric identifier is generated for each field point pair as follows. Measurements are taken of characteristics which do not include the field energy for the field points to generate the numeric identifier. In the example the following measurements are taken to generate the numeric identifier:
the field type (one of four) for each field point
the distance between the field points.

As in the earlier example, the two field types can be encoded into a number between 1 and 10. This number is used together with the distance value to obtain the numeric value.

For example the number between 1 and 10 can be added to the distance (rounded to an integer value) or an explicit mapping can be used. The explicit mapping could map all field point pairs of a first field type and a second field type in a certain distance range to a particular value. For example a positive and a negative field point between 4 Angstroms and 10 Angstroms apart (e.g. type negative, type positive, distance 6.7 Angstrom apart) could be mapped to a numeric identifier of 47.

For a bit string of length n, this numeric identifier can be used to generate a single number in the range of 1 to n, for example by using a simple one-to-one mapping. For instance, numeric identifier 47 can be used to generate, or be mapped to, the number 47 (i.e. element 47 in the string).

In this example the values in the string can take real number values (rather than being restricted to integer values). A measurement of the field energy for each of the field points in the field point pair is taken and the values are converted to a real number. This can be done by calculating the product or the sum of the two measurements. For example, if the type negative field point is size 6.23 and the type positive field point is size 2.09, then using the product the real number value (6.23×2.09) is calculated, whereas using the sum gives a real value (6.23+2.09).

The resulting real number value is added to the respective element of the string (element 47 in this example).

Using this approach, each position in the string (which can also be considered a vector) has a one-to-one correspondence with a “type” of field pair. For example element 47 in the string may be uniquely identified with “a positive and a negative field point pair between 4 Angstroms and 10 Angstroms apart”. The value stored in the element depends on the size of the field points, and is a real number.

Using such an approach each element of the string (or vector) corresponds to a (type 1, type 2, quantized distance) triplet (e.g. element 47 could stand for “negative, positive, 4-10 Angstroms apart”). Consequently, strings of a fixed, known length can be used.

Thus, in one embodiment which uses this approach the length of the string is set to the number of possible (type 1, type 2, distance) triplets; the deterministic function is set to the identity function (i.e. there is a one-to-one correspondence of the numeric identifier to a single number between 1 and n for a string of length n; and a real number value depending upon the size of the two field points is added to the bin (rather than the bin just being incremented or the bit being set, as described in relation to earlier examples).

Indexes in the form of bit strings representing field point representations are stored in a database to allow rapid searching of field point representations. The following section describes some techniques used to compare a search query with indexes in the database.

III. Searching the Database

Since a known index in the form of a bit string is used in particular embodiments of the present invention, known bit string manipulation techniques can be used, such as testing for substructures, testing for exact matches, Tanimoto coefficient testing, Euclidian distance testing, Tversky testing and Kulczynski testing.

In one embodiment a searching mechanism is used to search the database. The searching mechanism may be implemented on a computer system as software, firmware or hardware, although in a particular embodiment it is implemented as software.

Suitably, the searching mechanism is configured to:

(i) compare a query index with an index of a field point representation for a record in the database;

(ii) identify the record as a hit if the comparison satisfies a search criterion; and

(iii) repeat (i) and (ii) for a plurality of records.

The plurality of records can be all of the records in the database or a subset of these.

The searching mechanism can be further configured to:

receive a search query identifying a field point representation; and

form the query index by generating an index of the field point representation identified by the search query.

In one embodiment the searching mechanism is configured to form the query index by using the indexing mechanism to generate an index of the field point representation identified by the search query. Suitably, the searching mechanism is configured to generate the query index as a bit string.

The processes involved in the execution of field pattern searching in a particular example are given below.

1. Using a suitable interface, for example a GUI, a user selects

a. The field pattern to be used as the query. This may be from:
i. A conformations field pattern already registered to the database.
ii. An external file in the XED format (the system could be developed to allow external files in other formats to be used)

b. The comparison type to be used for the search.

c. If a similarity comparison is chosen the user is required to provide the maximum and minimum similarity range that will be regarded as a hit during the comparison.

d. The precision level at which the search should be carried out.

2. On submitting the query the interface passes information to the database.

3. The database then

a. Creates a fingerprint (bit string representation of the field pattern) for the query at the required precision level.

b. Creates a temporary table to hold the results.

C. Searches all of the fingerprint indexes (at the requested precision level) stored in the database.

d. Writes information to the temporary results table regarding any hit.

e. When the search is complete the database informs the interface in which table the results are held.

f. The interface then selects the information from the table and displays it to the user.

g. Once the user has finished viewing the results the interface tells the database to delete the table holding the results.

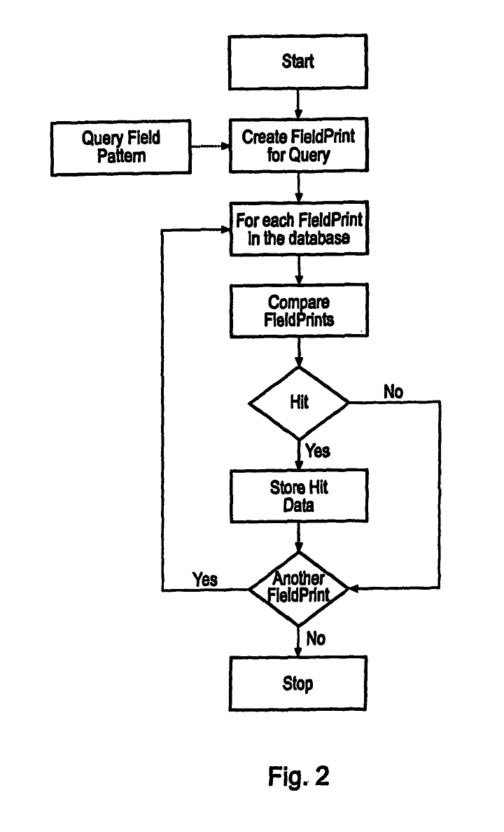

FIG. 2 is a flow diagram illustrating the fingerprint searching for the particular example.

In a particular embodiment the searching mechanism is configured to use a true/false matching technique to compare a search query with a record. True/false matching techniques that can be used in the current embodiment include an exact pattern technique, a sub pattern technique and a super pattern technique.

The searching mechanism can also be configured to use a similarity measuring technique to compare the search query with the record. In one embodiment, similarity measuring techniques that can be used include a Euclidian distance technique, a streetcar distance technique, a sub pattern similarity technique, a super pattern similarity technique, a Tanimoto similarity technique, a dice technique, and a Tversky similarity technique. A Kulczynski technique is used in a particular embodiment.

The searching mechanism is configured to identify a record as a hit dependent on a similarity measure produced by the similarity measuring technique being in a range from a minimum similarity value to a maximum similarity value.

In a particular embodiment the searching mechanism is configured to search by precision level. Suitably, this is done by generating an index of the field point representation at a required precision level to form the query index and comparing the query index with an index at the same precision level of a field point representation for a record in the database.

A user can submit a search query through a user interface. The searching mechanism stores the hits in a results table which is used to display the results to the user through the interface. In embodiments of the invention any suitable user interface, for example a graphical user interface (GUI), may be provided to enable a user to interact with the database.

Finally, it is noted that, although it is possible to apply the search method with a fixed similarity criterion (eg ‘return all records with a Tanimoto similarity >0.8’), it is usually preferable to calculate the similarity value for all records in the database, use these values to rank the database, and then output the top, i.e. most similar, N compounds.

IV. Database Overview

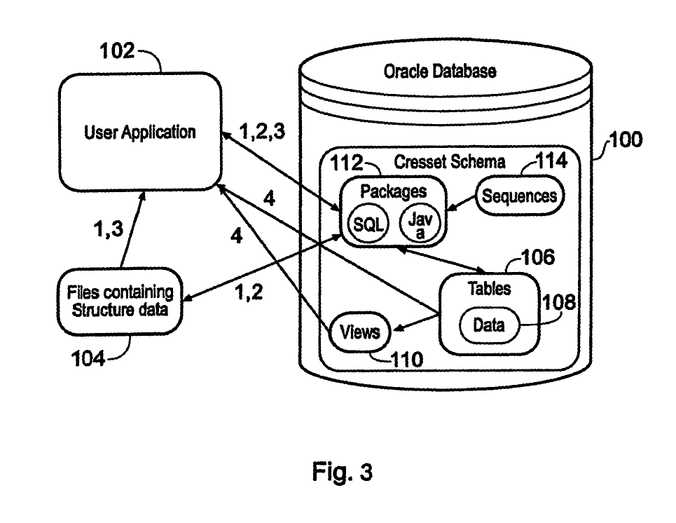

FIG. 3 shows an overview of the database. In the illustrated embodiment the database 100 is as an Oracle database (version 8.1.7 or greater). A separate user application 102 provides the GUI which is configured to enable a user to interface with data stored in the database. Files 104 containing structure data, including data representing field point representations, are also illustrated.

Import operations (illustrated as 1 in FIG. 3) include importing data from the files 104 to the user application 102, transferring data from the user application 102 to the database 100 and transferring data from the files 104 directly to the database 100. Export operations (illustrated as 2) include transferring data from the database 100 to the user application or to files 104. Searching (illustrated as 3) can be performed using the user application 102, optionally using data from a file 104. Browsing the database (illustrated as 4) can be performed using the user interface (e.g. a GUI) of user application 102.

The database comprises tables 106 comprising data 108 and views 110 for viewing data split across more than one table. The database also comprises packages 112 comprising public functions and procedures used by the user application and private functions and procedures used internally to execute particular tasks (for example to execute searching). The database also comprises sequences 114 for providing consecutive numbering for items in the database.

Referring back to the index mechanism and the searching mechanism, these are implemented as software functions/procedures in the database of the illustrated embodiment.

Creation and maintenance of the features within the database are achieved using conventional techniques and methods supported by the Oracle database environment. In the illustrated embodiment all procedures and functions have an SQL interface and the code executed by the procedure or function may be implemented in SQL or Java.

It will be appreciated that in the illustrated embodiment much of the functionality of the system is embedded within the database itself, for example for storing data, retrieving data and searching data. Communication between the user interface (e.g. a GUI)/user application 102 and database 100 is achieved using conventional protocols, for example ADO although any suitable protocol can be used.

The user application 102 is written in Visual Basic and may be run in any standard Windows PC environment. In the most part the user interface (e.g. a GUI) communicates with the database through the packages embedded within the database. The user interface can also directly access data from the tables for display purposes, such as record browsing.

The user interface enables a user to input data to the database, to output data from the database, to delete data from the database, to update data in the database, to browse the database, to search the database, and to display search results.

V. Database Structure

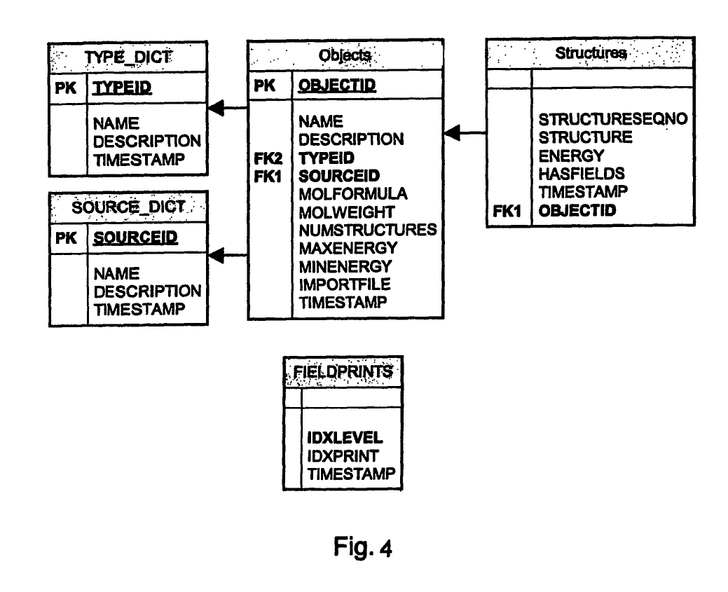

This section details the physical structure of the database schema of a particular embodiment. An overview of the tables of the database schema is given in FIG. 4.

The database schema is centred on the Objects table. This holds the top-level Information for each molecule registered. Each Molecule has a single entry in the objects table and is uniquely identified by a specific ID allocated at registration. This ID is used throughout the other tables in the schema to identify items related to that molecule. The structures table holds all of the structure information (an entry per conformation) for each molecule. This allows the structure of any conformation to be retrieved, interpreted and displayed by a suitable application connecting to the database. In the particular embodiment the structure information is held within the table as a Binary Large Object (BLOB) data-type.

General properties for each molecule are held in the objects table, whilst properties specific to a conformation are held each in the structures table.

When a molecule is registered to the database a Type and Source must be supplied. These must match allowed items for the Type and Source defined in the Type_Dict and Source_Dict tables.

The Source identifier allows the association of a molecule and hence its conformations with a particular source. The user may give any name to a source that has meaning to them. This could be used to track companies or projects within the database, for example MDR, HIV, or MayBridge.

The Type identifier allows the association of a molecule and hence its conformations with a particular type. The user may give any name to a type that has meaning to them. This could be used to track different entity types, for example Molecule, Fragment, Building Block or Field Template.

Any number of source and types can be created in the database, however only one source and type can be associated with a given molecule and its conformations.

The chemical structures stored in the Structures table are a complete representation of the information supplied at registration time i.e. chemical structure and field point representation (field pattern). However they are not used for searching. The schema provides a separate Fieldprints table to hold data generated at registration time which is more applicable to field searching.

V.1 Tables

The tables of the schema will be described in turn.

Objects Table

The objects table holds the top-level information for each entry in the database. One entry per molecule will exist in this table.

Where data integrity is to be maintained constraints have been created, i.e. it is not possible to register an entry to the table with an ID that already exists, or with a TypeID or SourceID that does not exist in the appropriate table.

Table Structure

| FIELD | DATA TYPE | NULL | DESCRIPTION | Constraint | Constraint LINK |
|---|---|---|---|---|---|
| OBJECTID | NUMBER (11) | N | Internal ID created | PKEY, | |
| | | | from a sequence | | |
| NAME | VARCHAR2 | N | Supplied data from | | |
| | (255) | | import file | | |
| DESCRIPTION | VARCHAR2 | Y | Supplied data from | | |
| | (255) | | import file | | |
| TYPEID | NUMBER (11) | N | Supplied data from list | FKEY | Type_Dict:Typeid |
| | | | of allowed types | | |
| SOURCEID | NUMBER (11) | Y | Supplied data from list | FKEY | Source_Dict:Sourceid |
| | | | of allowed dictionary | | |
| | | | sources | | |
| MOLFORMULA | VARCHAR (25 | Y | Calculated from the | | |
| 5) | | | structure | | |
| MOLWIEGHT | NUMBER | Y | Calculated from the | | |
| | (11, 4) | | structure | | |
| NUMSTRUCTURES | NUMBER (11) | Y | Calculated from the | | |
| | | | number of entries for | | |
| | | | this molecule | | |
| | | | registered in structures | | |
| | | | table. | | |
| MAXENERGY | NUMBER 11, 4 | Y | Calculated from the | | |
| | | | max energy of the | | |
| | | | conformations | | |
| | | | registered for this | | |
| | | | molecule in the | | |
| | | | structures table | | |
| MINENERGY | NUMBER 11, 4 | Y | Calculated from the | | |
| | | | min energy of the | | |
| | | | conformations | | |
| | | | registered for this | | |
| | | | molecule in the | | |
| | | | structures table | | |
| IMPORTFILE | VARCHAR2 | Y | The file the molecule | | |
| | (255) | | was imported from | | |
| TIMESTAMP | NUMBER 15 | N | System assigned | | |
| | | | registration date | | |

Structures Table

The structures table holds data about each and every conformation loaded into the database. A sequence number is assigned internally to differentiate the conformers for a particular molecule.

Table Structure

| FIELD | Data TYPE | NULL | DESCRIPTION | Constraint | Constraint LINK |
|---|---|---|---|---|---|
| OBJECTID | NUMBER | N | | FKEY | Objects:Objectid |
| | (11) | | | | |
| STRUCTURESEQ | NUMBER | N | The particular number of | | |
| NO | (11) | | conformation stored for | | |
| | | | this molecule | | |
| STRUCTURE | BLOB | N | Binary storage of the | | |
| | | | structure from the import | | |
| | | | file | | |
| ENERGY | NUMBER 11 | Y | Supplied data from | | |
| | | | import file | | |
| TIMESTAMP | NUMBER 15 | N | System assigned | | |
| | | | registration date | | |

Fieldprints Table

The Fieldprints table holds the data created for searching of the field point representation or field pattern. In the particular embodiment this data is created at various precision levels. Each precision level has an entry within the table. In the particular embodiment four precision levels are used.

A fingerprint is created for each and every conformation stored in the database from its field point representation. All fingerprints of the same precision level are combined into a single blob for rapid searching.

Table Structure

| FIELD | Data TYPE | NULL | DESCRIPTION | Constraint | Constraint LINK |
|---|---|---|---|---|---|
| IDXLEVEL | NUMBER (11) | N | The precision level at which the | PKEY | |
| | | | index was created | | |
| IDXPRINT | BLOB | N | The blob containing data at | | |
| | | | specified precision for all | | |
| | | | structures containing fields | | |
| TIMESTAMP | NUMBER 15 | N | System assigned registration | | |
| | | | date | | |

Type_Dict Table

This table stores all of the dictionary items that may be assigned to the molecule being registered.

Table Structure

| | | | | | Constraint |
|---|---|---|---|---|---|
| FIELD | Data TYPE | NULL | DESCRIPTION | Constraint | LINK |
| TYPEID | NUMBER (11) | N | Internal ID created from a | PKEY, | |
| | | | sequence | UNIQUE | |
| NAME | VARCHAR2 | N | User supplied data | | |
| | (255) | | | | |
| DESCRIPTION | VARCHAR2 | Y | User supplied data | | |
| | (255) | | | | |
| TIMESTAMP | NUMBER 15 | N | System assigned registration | | |
| | | | date | | |

Source_Dict Table

This table stores all of the dictionary items that may be assigned to the molecule being registered.

Table Structure

| | | | | | Constraint |
|---|---|---|---|---|---|
| FIELD | Data TYPE | NULL | DESCRIPTION | Constraint | LINK |
| SOURCEID | NUMBER (11) | N | Internal ID created from a | PKEY, | |
| | | | sequence | UNIQUE | |
| NAME | VARCHAR2 | N | User supplied data | | |
| | (255) | | | | |
| DESCRIPTION | VARCHAR2 | Y | User supplied data | | |
| | (255) | | | | |
| TIMESTAMP | NUMBER 15 | N | System assigned registration | | |
| | | | date | | |

Results_(X) Table

This table stores the results obtained from any fingerprint search and is transitional.

Each fingerprint search will have its own results table created and is identified by the _(X) part of the table name. The X is assigned internally as the next number from a sequence.

This table is usually deleted when no longer required by the user application

Table Structure

| | | | | | |
|---|---|---|---|---|---|
| | | | | | Constraint |
| FIELD | Data TYPE | NULL | DESCRIPTION | Constraint | LINK |

| | | |
|---|---|---|
| OBJECTID | NUMBER (11) | N |
| OBJECTIDSEQNO | NUMBER (11) | Y |
| SIMILARITY | NUMBER (6) | Y |

Any suitable database and database schema may be used to implement the present invention.

V.2 Database Packages

The use of functions and procedures within the Oracle database environment allows complex tasks to be completed with a single call to the database. They also provide a way of masking the complexity of the database to a user or application, i.e. the user does not have to know the internal detail of the database schema, to register various bits of information, they need only supply the data to a procedure or function happy in the knowledge that the method knows how to deal with it.

Functions and procedures can also be amalgamated into packages. In the present implementation, the call interface for all functions and procedures is declared using SQL since this is the language of the database environment. However the executable code may be written in SQL, C, Java, or a mixture of these languages.

The use of packages allows procedures and functions to be specified as public and private. Calls made externally to the database may only use public methods.

The database environment of the present embodiment has three packages. One package (PACK_CBMD_REG) is concerned with registration of molecules and their conformations along with all of the information (such as the fingerprints) into the database tables. A second package (PACK_CBMD_CHEM) is concerned with searching the fingerprint (the indexes). A third package (PACK_CBMD_UTILS) contains general utilities used by the other two packages.

VI. Computer System

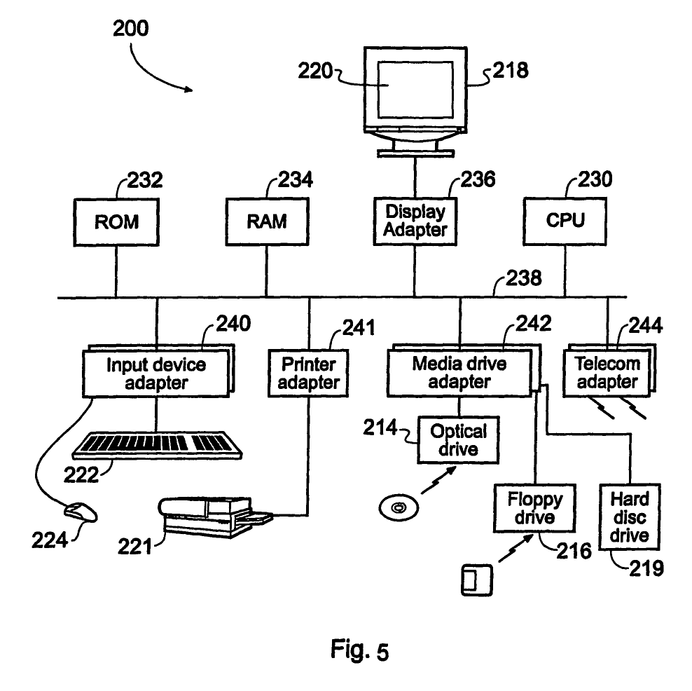

FIG. 5 shows a schematic and simplified representation of a computer system 200. The computer system 200 comprises various data processing resources such as a processor (CPU) 230 coupled to a bus structure 238. Also connected to the bus structure 238 are further data processing resources such as read only memory 232 and random access memory 234. A display adapter 236 connects a display device 218 having screen 220 to the bus structure 238. One or more user-input device adapters 240 connect the user-input devices, including the keyboard 222 and mouse 224 to the bus structure 238. An adapter 241 for the connection of the printer 221 may also be provided. One or more media drive adapters 242 can be provided for connecting the media drives, for example the optical disk drive 214, the floppy disk drive 216 and hard disk drive 219, to the bus structure 238. One or more telecommunications adapters 244 can be provided for connecting the computer system to one or more networks or to other computer systems or devices.

In operation the processor 230 runs computer software by executing computer program instructions and operating on data that may be stored in one or more of the read only memory 232, random access memory 234 the hard disk drive 219, a floppy disk in the floppy disk drive 216 and an optical disc, for example a compact disc (CD) or digital versatile disc (DVD), in the optical disc drive or dynamically loaded via adapter 244. The results of the processing performed may be displayed to a user via the display adapter 236 and display device 218. User inputs for controlling the operation of the computer system 200 may be received via the user-input device adapters 240 from the user-input devices.

Computer software comprising data files and executable files or computer programs for implementing various functions or conveying various information can be written in a variety of different computer languages and can be supplied on carrier media. Software comprising a program or program element may be supplied on one or more CDs, DVDs and/or floppy disks and then stored on a hard disk, for example. Software may also be embodied as an electronic signal supplied on a telecommunications medium, for example over a telecommunications network. Examples of suitable carrier media include one or more selected from: a radio frequency signal, an optical signal, an electronic signal, a magnetic disk or tape, solid state memory, an optical disk, a magneto-optical disk, a compact disk and a digital versatile disk.

It will be appreciated that the architecture of a computer system could vary considerably and FIG. 5 is only one example.

In the present example computer software configured to provide the database is stored on the computer system.

### REFERENCES

[1] ‘Substructure search of chemical structure files’; pp 157-181, and ‘Chemical structure search systems and services’; pp 182-202, in communication, storage and retrieval of chemical information, Ash J., Chubb P., Welford S., Willet P. (Eds). Ellis Horwood, Chichester, 1985.
[2] Barnard J. M.; ‘Structure representation and searching’; pp 9-56, in Chemical Structure Systems, Ash J. E., Warr W. A., Willet P. (Eds), Ellis Horwood, Chichester, 1991.
[3] Mooers C. N.; ‘Zatocoding applied to mechanical organization of knowledge’; Amer. Doc., 2, 20-32, January 1951.
[4] Mooers C. N.; ‘Zatocoding and developments in information retrieval’; ASLIB Proceedings, 8(1), 3-22, February 1956.
[5] J G Vinter: Journal of Computer-Aided Molecular Design: volume 8(1994) pages 653-668.
[6] J G Vinter and K I Trollope: Journal of Computer-Aided Molecular Design: volume 9(1995) pages 297-307.

1. A computer system comprising a database having a plurality of records, wherein each record comprises a field point representation representing field extrema for a conformation of a chemical structure, each record having an index of the field point representation, wherein the index is a searchable representation of the field point representation and the index is a string.

2. The computer system of claim 1, wherein the database includes records for multiple conformations of the same chemical structure.

3. The computer system of claim 1r, wherein each record further comprises a structural representation of the chemical structure.

4. (canceled)

5. (canceled)

6. The computer system of claim 1, each record having multiple indexes of the field point representation, wherein the multiple indexes are representations of the field point representation at different precision levels.

7. The computer system of claim 1, comprising an indexing mechanism for generating an index of a field point representation.

8. The computer system of claim 7, wherein an index is a string of length n and the indexing mechanism is configured to:
(i) generate a numeric identifier from a characteristic of the field point representation;
(ii) generate one or more numbers in a range from 1 to n in dependence on the numeric identifier;
(iii) increment the bins in the string that correspond to the one or more numbers; and
(iv) optionally repeat (i) to (iii) for another characteristic of the field point representation.

9. The computer system of claim 8, wherein a characteristic of the field point representation includes one or more of:
the number of field points of a particular field of the field point representation;
the particular field and energy of a field point in the field point representation; and
the respective energies of and distance between a field point pairing in the field point representation.

10. The computer system of claim 8, wherein the indexing mechanism is configured to take a measurement of a characteristic of the field point representation to generate the numeric identifier.

11. The computer system of claim 10, wherein the indexing mechanism is configured to take a measurement of the characteristic of the field point representation at different levels of precision to generate corresponding multiple indexes which represent the field point representation at different precision levels.

12. The computer system of claim 8, wherein the indexing mechanism is configured to:
(i) define a plurality of ranges of possible measurement values;
(ii) take a measurement of a characteristic of the field point representation to produce a measurement value;
(iii) assign the measurement value to a range if the measurement value is within the range;
(iv) optionally repeat (ii) and (iii); and
(v) use the number of measurement values assigned to the range to generate the numeric identifier.

13. The computer system of claim 12, wherein the indexing mechanism is configured to define ranges of equal width across all ranges.

14. The computer system of claim 12, wherein the indexing mechanism is configured to define a range for smaller measurement values with a narrower width than a range for larger measurement values.

15. The computer system of claim 12, wherein the indexing mechanism is configured to generate multiple indexes by defining ranges of different widths for different precision levels.

16. The computer system of claim 8, wherein the indexing mechanism is configured to generate one or more numbers in a range from 1 to n in dependence on the numeric identifier by using a deterministic function.

17. The computer system of claim 16, wherein the deterministic function is a pseudo-random number generator or a hash function.

18. The computer system of claim 8, wherein the bins in the string take real number values.

19. The computer system of claim 18, wherein the real number value is generated from the energies of a pair of field points in the field point representation.

20. The computer system of claim 1, comprising a searching mechanism for searching the database.

21. The computer system of claim 20, wherein the searching mechanism is configured to:
(i) compare a query index with an index of a field point representation for a record in the database;
(ii) identify the record as a hit if the comparison satisfies a search criterion; and
(iii) repeat (i) and (ii) for a plurality of records.

22. The computer system of claim 21, wherein the searching mechanism is further configured to:
receive a search query identifying a field point representation;
form the query index by generating an index of the field point representation identified by the search query.

23. The computer system of claim 20, wherein the search mechanism is configured to search by precision level.

24. A database for implementation on a computer system, the database configured to support a plurality of records, each record comprising a field point representation representing field extrema for a conformation of a chemical structure, the database further configured to support each record having an index of the field point representation, wherein the index is a searchable representation of the field point representation and the index is a string.

25. (canceled)

26. (canceled)

27. The database of claim 24, configured to support each record having multiple indexes of the field point representation, wherein the multiple indexes are representations of the field point representation at different precision levels.

28. The database of claim 24, comprising an indexing mechanism for generating an index of a field point representation.

29. The database of claim 24, comprising a searching mechanism for searching the database.

30. Computer software configured to provide the database of claim 24.

31. A carrier medium carrying computer software configured to provide the database of claim.

32. A method of generating an index of a field point representation representing field extrema for a conformation of a chemical structure, wherein the index is a string with n elements, the method comprising:
(i) generating a numeric identifier from a characteristic of the field point representation;
(ii) generating one or more numbers in a range from 1 to n in dependence on the numeric identifier;
(iii) incrementing the string elements that correspond to the one or more numbers; and
(iv) optionally repeating (i) to (iii) for another characteristic of the field point representation.

33. The method of claim 32, comprising taking a measurement of a characteristic of the field point representation to generate the numeric identifier.

34. The method of claim 33, comprising taking the measurement of the characteristic of the field point representations at different levels of precision to generate corresponding multiple indexes which represent the field point representation at different precision levels.

35. The method of claim 32, comprising
(i) defining a plurality of ranges of possible measurement values;
(ii) taking a measurement of a characteristic of the field point representation to produce a measurement value;
(iii) assigning the measurement value to a range if the measurement value is within the range;
(iv) optionally repressing (ii) and (iii); and
(v) using the number of measurement values assigned to a range to generate the numeric identifier.

36. The method of claim 35, comprising defining ranges of equal width across all ranges

37. The method of claim 35, comprising defining a range for smaller measurement values with a narrower width than a range for larger measurement values.

38. The method of claim 35, comprising generating multiple indexes by defining ranges of different widths for different precision levels.

39. The method of claim 32, comprising using a deterministic function to generate one or more numbers in a range from 1 to n in dependence on the numeric identifier.

40. The method of claim 39, wherein the deterministic function is a pseudo-random number generator or a hash function.

41. A method of searching a database having a plurality of records, each record comprising a field point representation representing field extrema for a conformation of a chemical structure and having an index of the field point representation wherein the index is a string, the method comprising:
(i) comparing a query index with an index of a field point representation for a record in the database;
(ii) identifying the record as a hit if the comparison satisfies a search criterion;
(iii) repeating (i) and (ii) for a plurality of records; and
(iv) outputting a representation of the records identified as a hit.

42. The method of claim 41, further comprising:
receiving a search query identifying a field point representation; and
forming the query index by generating an index of the field point representation identified by the search query.

43. The method of claim 41, the method further comprising searching by precision level.
